(19) United States
(12) Patent Application Publication
(10) Pub. No.: US 2026/0195607 A1
(43) Pub. Date: Jul. 9, 2026

(54) Federated Learning with Steering Vectors

(71) Applicant: Google LLC, Mountain View, CA (US)

(72) Inventors: Florian Nils Hartmann, Zurich (CH); Matthew Sharifi, Kilchberg (CH)

(21) Appl. No.: 19/012,414

(22) Filed: Jan. 7, 2025

(51) Int. Cl. G06N 3/098

(52) U.S. Cl. CPC G06N 3/098

(57) ABSTRACT

There is disclosed a method for federated learning implemented by a client device. The method comprises obtaining a model input and processing, by a neural network comprising one or more neural network layers, the model input to generate a model output. The method further comprises caching the activations of one or more selected layers of the neural network generated from processing the model input by the neural network and generating a label based upon a user interaction with the model output. The method further comprises transmitting, to a server, training data based upon the cached activations and corresponding labels for generating one or more steering vectors for the one or more selected layers.

### TECHNICAL FIELD

This specification relates to systems and methods for federated learning, in particular, through the use of steering vectors.

### BACKGROUND

Neural network models comprise a plurality of parameters organized into a set of hierarchical layers. A neural network model can process a model input through the set of layers to generate a model output. A neural network model can be trained to perform a task using a training algorithm such as backpropagation. Neural network models can be trained in a distributed manner using federated learning.

### SUMMARY

According to a first aspect, there is provided a method for federated learning implemented by a client device. The method comprises obtaining a model input and processing, by a neural network comprising one or more neural network layers, the model input to generate a model output. The method further comprises caching the activations of one or more selected layers of the neural network generated from processing the model input by the neural network and generating a label based upon a user interaction with the model output. The method further comprises transmitting, to a server, training data based upon the cached activations and corresponding labels for generating one or more steering vectors for the one or more selected layers.

According to a second aspect, there is provided a method for federated learning implemented by a server. The method comprises receiving training data comprising activations for one or more selected layers of a neural network from one or more first client devices and for each respective selected layer, aggregating the activations for the respective selected layer to generate a steering vector for the respective selected layer. The method further comprises transmitting, to the one or more first client devices, the generated steering vectors.

According to a third aspect, there is provided a method for neural network processing implemented by a client device. The neural network comprises one or more neural network layers. The method comprises receiving, from a server, one or more steering vectors associated with one or more selected layers of the neural network; obtaining a model input; and processing, by the neural network, the model input to generate a model output. The processing comprises generating activations for each layer of the neural network; wherein after generating the activation for a respective selected layer of the neural network, applying the corresponding steering vector for the respective selected layer to generate a modified activation for that layer; and wherein generating the activations for all subsequent layers having the respective selected layer as an input is based upon the modified activation.

According to a fourth aspect, there is provided a non-transitory computer-readable storage medium comprising instructions that when executed by one or more data processing apparatus cause the one or more data processing apparatus to carry out a method according to any of the first to third aspects.

According to a fifth aspect, there is provided a system comprising one or more data processing apparatus and a memory storing instructions that when executed by the one or more data processing apparatus, causes the one or more data processing apparatus to carry out a method according to any of the first to third aspects.

It will be appreciated that features disclosed in the context of one aspect may be combined with features disclosed in the context of one or more other aspects.

Particular embodiments of the subject matter described in this specification can be implemented so as to realise one or more of the following advantages.

Federated learning can be used to train neural network models in a distributed manner. Client devices can compute local updates to a neural network model using data local to the client device. The local updates are provided to a central server and aggregated to update a global model stored at the server. The global model can be provided back to the client devices for further rounds of training. The training data is not transmitted off the client devices. Typically, backpropagation is used for determining the local model updates. Backpropagation is more memory intensive than computing a forward pass of the network to generate model output. Thus, it is possible for a neural network to be deployable on a client device but the client device is unable to perform backpropagation due to its limited memory.

The techniques described herein uses steering vectors instead of backpropagation for adjusting the behaviour of the neural network. As the data necessary for computing steering vectors can be computed through a forward pass of the neural network only, the techniques can be implemented on any client device that the neural network can be deployed on. Federated learning can be used to learn appropriate steering vectors in a distributed system.

### BRIEF DESCRIPTION OF THE DRAWINGS

FIG. 1 is a schematic block diagram illustrating an example of a client device.

FIG. 2 is a schematic block diagram illustrating an example server in communication with a plurality of client devices.

FIG. 3 is a schematic block diagram illustrating a further example of a client device.

FIG. 4 is a flowchart illustrating an example method of federated learning implemented using a client device.

FIG. 5 is a flowchart illustrating an example method of federated learning implemented using a server.

FIG. 6 is a flowchart illustrating an example method of neural network processing implemented using a client device.

Like reference numbers and designations in the various drawings indicate like elements.

### DETAILED DESCRIPTION

Federated learning has been used to train neural network models on data generated at client devices without having to transmit that data off the device. In general in federated learning, a central server is responsible for maintaining the neural network model. Client devices that are participating in federated learning each receives a copy of the neural network model. The client devices each carry out training of the neural network model on their locally generated data to determine a model update. Each client device transmits their locally determined model update to the central server. The central server then updates the neural network model based upon an aggregation of the locally determined model updates. Further iterations can be carried out to continue training or once training is completed, the final version of the neural network model can be deployed to client devices. Generally, transmitting model updates requires much less network bandwidth than transmitting training data from a client device to the central server. Thus, federated learning provides for both data security/privacy and a reduction in the network bandwidth requirements by keeping data on-device.

The capabilities of neural network models are ever improving. However, this can also mean that neural network models are also growing in size. Large language model-type neural networks can have billions of parameters. Typically, client devices such as smartphones and other mobile/edge devices have limited computational resources, e.g. limited memory, processing power and battery life. Large neural network models can be deployed on devices with limited memory resources given that when a model input is being processed, only the output of the previous layer in the neural network is necessary for computing the output of a current layer and as such, parameters and activations can be swapped in and out of memory as needed. The entirety of the neural network model does not need to be kept in memory.

However, when carrying out neural network training using backpropagation, all of the network's forward pass activations as well as the errors and gradients for the backward pass are needed in memory to determine a model update. Therefore, training large neural networks on some devices can be infeasible even if that model can be deployed and run on the device. Therefore, it is possible that conventional federated learning cannot be used if the client device does not have sufficient memory for training the neural network model even if the model could be deployed on the device. Furthermore, network bandwidth requirements for federated learning are also higher for larger models.

The techniques described herein provides for an alternative to conventional federated learning by using steering vectors instead of model updates computed using backpropagation. A steering vector is a vector that can be applied to the activations (e.g. output) of a layer of the neural network during the forward pass when processing a model input to generate a model output. An appropriately constructed steering vector can influence the neural network to generate a model output having certain desired characteristics. A federated learning type scheme can be used to learn an appropriate steering vector for altering the behaviour of neural networks that are deployed on client devices.

In general, when a client device processes a model input using a neural network to generate a model output, the client device can cache the activations generated for one or more selected layers of the neural network. When the client device receives user feedback regarding the generated model output, a label can be generated and associated with the corresponding activations. For example, the labels can be binary labels indicating positive or negative user feedback. In such a case, it is desirable to alter the behaviour of the neural network to generate model output that is more similar to model output having positive user feedback than negative user feedback. A steering vector can be constructed based upon the difference in the average activations between the positive and negative examples. A central server can determine a global steering vector from the collected activation data from participating client devices. The global steering vector can then be transmitted to client devices and the client devices can then apply the steering vector to alter the behaviour of the neural network when next processing a model input.

Thus, given that determining steering vectors only requires the activations of selected layers generated in the forward pass, the techniques can be used on any device that the neural network model can be deployed on. In addition, as only activation data relating to selected layers of the neural network are transmitted, this requires less network bandwidth than transmitting a full model update relating to the whole network. Furthermore, as full user data is not transmitted off-device, data security/privacy can be maintained. As a backward pass is not required, the technique is more computationally efficient and consumes less energy which can be important for preserving battery life on mobile devices.

The techniques described herein can allow for ongoing adjustment of neural networks deployed on client devices without having to incur the computational cost of ongoing training using backpropagation or other computationally expensive training methods.

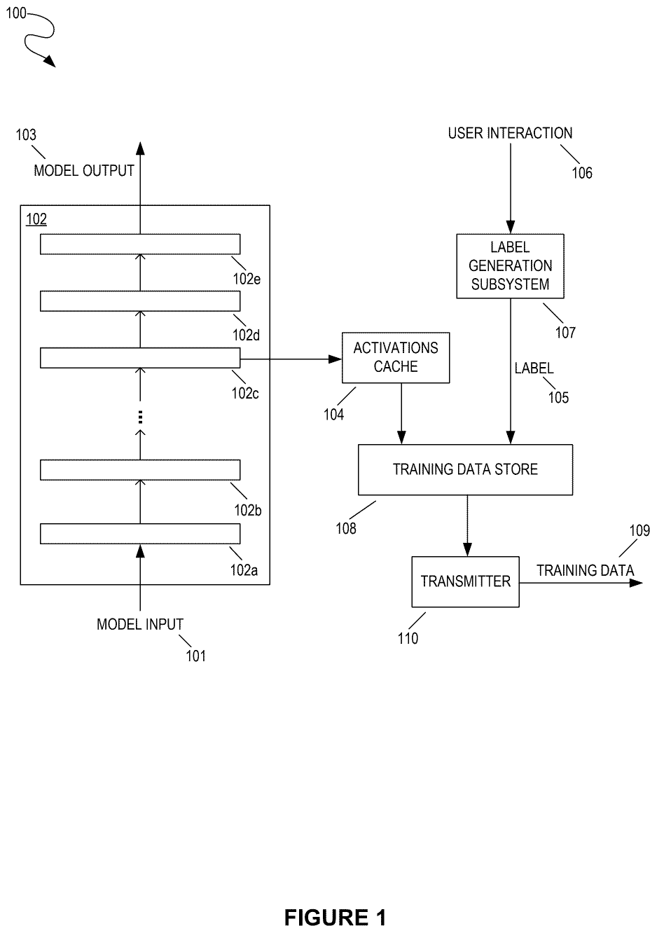

Referring now to FIG. 1, a client device 100 is shown. The client device 100 can be a mobile device such as a smartphone, tablet, laptop, or an edge device such as an Internet of Things device. In some implementations, the client device 100 can have limited computational resources, such as limited memory and processing power. However, more generally, the client device 100 can be any type of data processing apparatus. The client device 100 can comprise any number of and any type of processing unit such as CPU, GPU, TPU or other specialized hardware apparatus such as an FPGA or ASIC for carrying out the processing described below.

The client device 100 is configured to obtain a model input 101. In some implementations, the model input 101 can be based upon a user interaction with the client device 100. In addition, or alternatively, the model input 101 can be generated by a particular software application or AI agent. The client device 100 includes a neural network 102 that is configured to process the model input 101 to generate a model output 103. The neural network 102 can be a network that has been trained by another system to carry out a particular task.

For example, on devices without a physical keyboard, a software keyboard application can use a neural network to provide auto-complete suggestions when the user is composing text. In another example, the neural network can be configured to determine misspellings and/or errors in grammar in a passage of text. In a further example, the neural network can be configured to generate a summary of emails, web-pages, notifications or any other appropriate document. In another example, on a touchscreen device, when a user attempts to select text from a document, e.g. by tapping on a portion of the text, a neural network can be used to determine the extent of the selection, for example if the selection is part of a URL, phone number, email address, postal address etc. the whole extent might be selected even if the user has only tapped on a few characters. In another example, the neural network can be configured as a writing assistant, e.g. to provide suggestions according to a specified writing style, e.g. polite, professional, concise etc. More generally, the neural network can be configured to provide a response to an input query from a user.

In a further example, the neural network can be configured to generate image, video and/or audio data from input text comprising instructions describing what to generate. In another example, the neural network can be configured to analyse an image and to provide an enhanced version of the image, e.g. to remove noise, correct brightness and colour balance etc. Further exemplary neural network tasks are described in more detail below.

In FIG. 1, the neural network comprises a plurality of neural network layers 102a-102e with some layers omitted for clarity. The neural network 102 can have any number of layers and any appropriate architecture suitable for carrying out its intended task. For example, the neural network 102 can be based upon and include any combination of a Transformer architecture, a diffusion neural network, a convolutional neural network, a recurrent neural network, an LSTM, a multi-layer perceptron or any other type of neural network.

The client device 100 is further configured to cache the activations of one or more selected layers of the neural network 102 that are generated from processing the model input 101 by the neural network 102. In the example of FIG. 1, the activations of network layer 102c are stored in an activation cache 104. In some implementations, the activations of a selected layer is the output of that particular layer. In other implementations, the activations can be any intermediate result produced by that layer. For sequential outputs, an average over the activations for each position in the sequence can be taken or the activations of the last position in the sequence can be taken or any other suitable scheme can be used.

In some implementations, the activations of the one or more selected layers are stored during processing of the model input 101 to generate the model output 103. In other implementations, which layer(s) are to be the selected layer(s) may not be known at the time the model input 101 is generated and processed by the neural network 102. In such cases, the model input 101 can be stored and after the client device 100 is provided with an indication of the one or more selected layers, the client device 100 can be configured to retrieve the model input 101 and to reconstruct the activations for the one or more selected layers. In these cases, it may only be necessary to run neural network processing up to the last selected layer rather than running the neural network processing to completion in order to cache the activations of the one or more selected layers given that the model output is not required.

The choice of which layer(s) to select can be considered to be a hyperparameter and can be selected according to any appropriate hyperparameter selection method such as a grid search. In addition, or alternatively, the neural network 102 can be analysed offline to determine the features of the input that particular neurons/layers are most responsive to/attempts to model. Generally, the higher layers of a neural network relate to more conceptual features whilst the lower layers typically relate to low-level features of the input. Typically, a layer towards the middle of the network is selected.

The client device 100 is further configured to generate a label 105 based upon a user interaction 106 with the model output 103. For example, the client device 100 can be configured to present user interface elements for providing direct feedback on the model output 103. For instance, selectable “thumbs-up” and “thumbs-down” icons can be presented to the user with the model output 103. The user can then indicate their approval or disapproval of the model output 103 by selecting the appropriate icon. Direct user feedback can be appropriate when the neural network is responding to a particular user request, e.g. to generate image, video, audio data, or to generate text data such as a summary, compose an email, or generally to answer a user query as discussed above.

In other examples, a label 105 can be derived indirectly from how the user chooses to interact with the model output 103. For example, if the neural network 102 is configured to highlight grammar errors in a passage of text and the user chose to ignore a particular error, this can provide a signal that similar errors should not be flagged by the neural network 102 again. In another example, if the user requests regeneration of the model output 103, this can indicate that the user was not satisfied with the generated model output 103 and the neural network 102 should avoid generating similar output for similar model input 101.

Thus, in some implementations, the label 105 can be a binary label that is indicative of positive or negative user feedback with respect to the model output 103 (which can be derived from direct or indirect user feedback). In other implementations, the labels can be multi-class labels. The client device 100 can include a label generation subsystem 107 configured to carry out the generation of the label 105.

The client device 100 can be further configured to generate a training example based upon the generated label 105 and the corresponding activation. The client device 100 can be configured to build a set of training data by processing further model inputs by the neural network 102 and caching the activations of the one or more selected layers of the neural network 102 and generating corresponding labels for the cached activations.

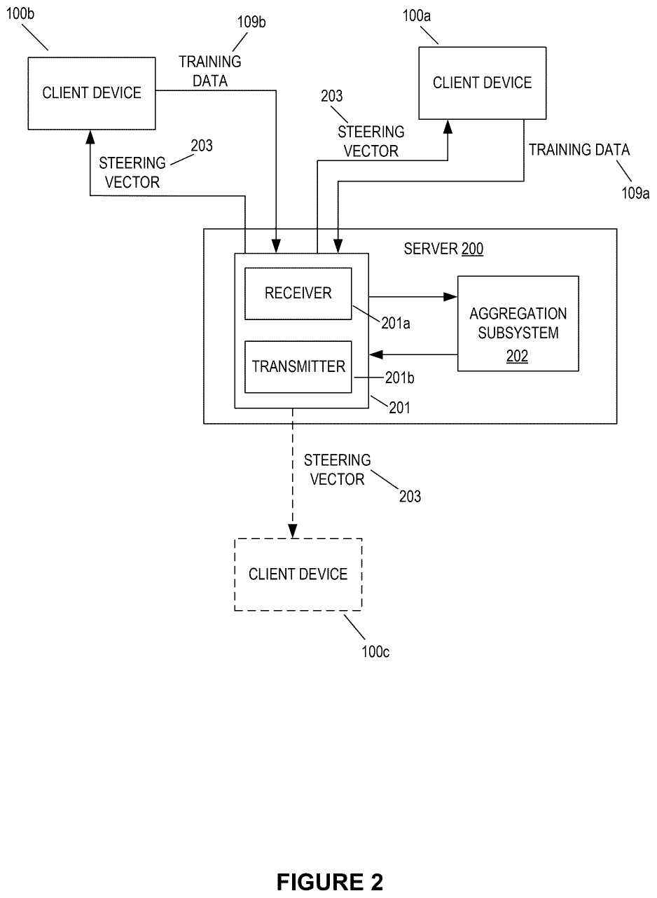

In some implementations, a training example can simply comprise the activations and the corresponding label. In other implementations, the activations can undergo further processing to generate the training data. For example, the activations can be modified using the corresponding labels. In one example, where the labels are binary labels, the activations corresponding to a negative class can be multiplied by a negative value such as −1 to provide a weighted activation. The activations corresponding to a positive class can be unchanged or multiplied by a positive value. In some implementations, the activations that have been modified using the corresponding labels can be aggregated, e.g. the positively weighted activation values and negatively weighted activation values can be summed to effectively compute a weighted average of the activations. In other words, the difference between the average activations of a positive class and the average activations of a negative class can be computed. In this way, the resulting difference vector can provide particular activation values that can be used to bias the behaviour of the neural network towards one class or the other during inference, e.g. by adding the difference vector to activations to bias the network towards the positive class or by subtracting the difference vector from activations to bias the network towards the negative class. The difference vector can be considered to be a locally computed steering vector. However, given that the data used to compute this local steering vector only comes from a single device and is relatively small in quantity, it is likely to be noisy. Therefore, aggregation with many other locally determined steering vectors can provide a better estimate of the steering vector necessary to alter the behaviour of the neural network 102. This aggregation can be carried out using a central server and is described in more detail below with reference to FIG. 2. It will be appreciated that whilst the above describes the use of an average for aggregation, other aggregation methods can also be used. Likewise, whilst the above computes a difference by subtraction, other distance metrics can also be used instead.

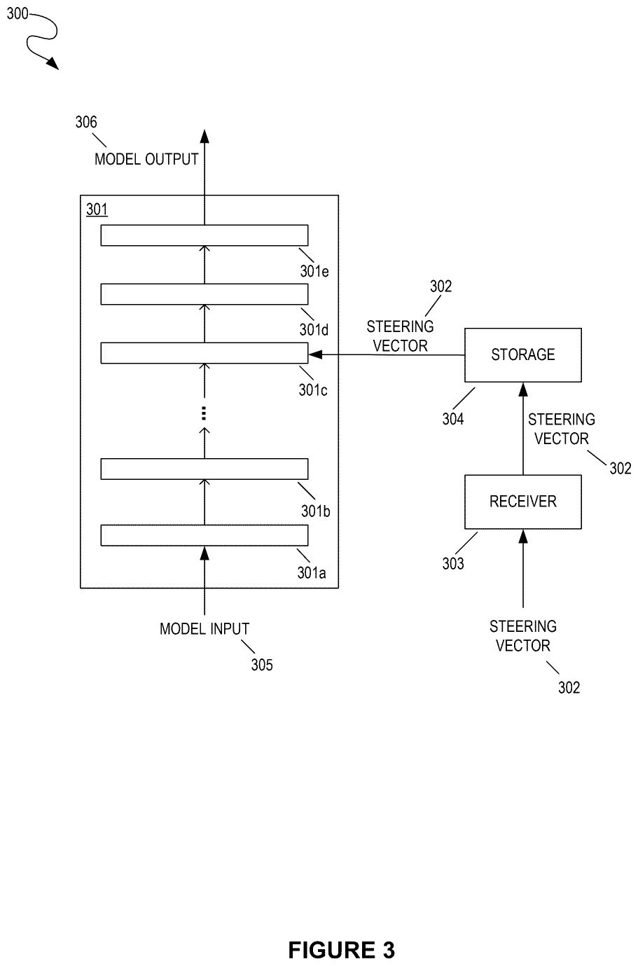

The client device 100 can be configured to receive from the server, one or more steering vectors for subsequent application to the activations of the one or more selected layers when carrying out processing using the neural network 102. This is described in more detail below with reference to FIG. 3.

Where there are multiple classes, it is possible to generate a local steering vector for each class. For example, a one-vs-all scheme can be used whereby the activations for a particular class can be aggregated and a difference computed against the aggregated activations of all other classes. Alternatively, any other suitable scheme can be used.

The client device 100 can include a training data store 108 for storing the generated training data. As described above, the training data can comprise unmodified cached activations, the cached activations modified using their corresponding labels, or an aggregation of the cached activations (either modified or unmodified). The training data can comprise the corresponding labels as appropriate.

The client device 100 is further configured to transmit training data 109 to a server for generating one or more steering vectors for the one or more selected layers of the neural network 102. An exemplary server is shown in FIG. 2 and described in more detail below. The client device 100 can include a transmitter 110 configured to transmit the training data 109. The training data 109 can be transmitted using any appropriate network connection such as a LAN, a WLAN, cellular connection, Internet connection etc.

In some implementations, the client device 100 is configured to transmit the training data 109 in response to a request received from the server. For example, the client device 100 can be configured to transmit a notification to the server of the number of examples of each label that has been collected on the client device 100. As described in more detail below, the server can receive notifications from other client devices and select certain client devices to receive training data from. As such, when the server selects a client device, the server can transmit a request to the client device for training data. In some implementations, only a subset of the training data available on the client device 100 is transmitted in accordance with the request received from the server. For example, the request can comprise an indication of the number of examples per class that is required. If the number of available examples exceeds the number of examples requested, a random selection of the required number can be carried out or another suitable selection technique can be used.

In order to enhance the privacy and security of the transmitted data, Differential Privacy and/or Secure Aggregation techniques can be used. For example, the client device 100 can be configured to modify the training data 109 based upon a Differential Privacy technique prior to transmittal. Generally, Differential Privacy techniques involve bounding and adding random noise to data such that removing or adding a single device's contribution to an aggregation, causes only a small change to the distribution of the aggregate result. This limits the amount of information that can be inferred from an individual device's data from the aggregate result whilst maintaining the utility of the aggregate result. Further details regarding Differential Privacy can be found in McMahan, H. Brendan, et al. “Learning differentially private recurrent language models.” arXiv preprint arXiv:1710.06963 (2017) which is hereby incorporated by reference in its entirety.

In some implementations, the client device 100 can be configured to transmit the training data 109 based upon a Secure Aggregation protocol. In general, Secure Aggregation involves each client device that contributes data to a round of aggregation at the server agreeing between them on a set of perturbations to apply to the training data before transmittal. The applied set of perturbations are such that when all the data is aggregated at the server, the perturbations are cancelled out. This enables individual devices to mask their data without affecting the aggregated result thereby protecting the security and privacy of the data. Some implementations can involve the use of public/private keys and the server can be used for mediating key agreement. Further details regarding Secure Aggregation can be found in Bonawitz, Keith, et al. “Practical secure aggregation for federated learning on user-held data.” arXiv preprint arXiv:1611.04482 (2016) which is hereby incorporated by reference in its entirety.

In some implementations, the client device 100 can be configured to apply a sparsity mask to the training data 109 prior to transmittal. The sparsity mask can define which elements of an activation vector to set to zero and which elements to retain. For example, when the training data comprises an aggregation of the cached activations, any values which are close to zero (e.g. below a certain threshold) can be marked for setting to zero. Alternatively, the top-N highest values can be marked for retention whilst all other values can be marked for setting to zero. In other implementations, the sparsity mask can be computed based upon the observed range of values of the cached activations, or using other methods, to determine the potential influence of each element. Those with low influence could be marked for setting to zero. In some implementations, the client device 100 is configured to negotiate and agree on a sparsity mask with other participating client devices. For example, each client device can exchange their proposed sparsity masks and combine them (e.g. by OR-ing each sparsity mask if the sparsity mask is a binary vector) to form the sparsity mask that is to be used. Where Secure Aggregation is used, the sparsity masks can be exchanged during the exchange of perturbation values. Once a final sparsity mask has been determined, the client device 100 can be configured to apply the sparsity mask to the training data 109 to set the corresponding values to zero. By sparsifying the training data prior to transmittal, the number of non-zero values can be reduced thereby reducing the network transmission cost.

Referring now to FIG. 2, a server 200 is shown in communication with a plurality of client devices 100a-100c. The plurality of client devices 100a-100c can each be implemented according to the client device 100 of FIG. 1 described above. Whilst FIG. 2 shows three client devices, it will be appreciated that the server 200 can be in communication with any number of client devices as appropriate. In some implementations, there can be hundreds or thousands of client devices participating. The server 200 and the plurality of client devices 100a-100c can be in communication via any appropriate network connection such as a LAN, WLAN, cellular connection, Internet etc. The server 200 can include a network subsystem 201 comprising a receiver 201a that is configured to receive data from the plurality of client devices 100a-100c and a transmitter 201b that is configured to transmit data to the plurality of client devices 100a-100c.

The server 200 can be any appropriate data processing apparatus and can comprise any number of and any type of processing unit such as CPU, GPU, TPU or other specialized hardware apparatus such as an FPGA or ASIC for carrying out the processing described below.

The server 200 is configured to receive training data 109a, 109b comprising activations for one or more selected layers of a neural network from one or more first client devices 100a and 100b. As discussed above, the activations can be in an aggregated form or can comprise individual examples of activations with corresponding labels.

The server 200 is further configured to, for each respective selected layer, aggregate the activations for the respective selected layer to generate a steering vector for the respective selected layer. For example, if individual examples of activations are received from the one or more first client devices, a difference between the average activations for a positive class can be computed against the average activations for a negative class as described above, e.g. by multiplying each individual activation example associated with the negative class by-1 and then summing all activations together. If the activations are received in aggregated form, e.g. local steering vectors are received from each of the first client devices, an average of the local steering vectors weighted by the number of examples used to generate each local steering vector can be computed in order to determine a global steering vector. It will be appreciated that other forms of aggregation can be used as deemed appropriate by a person skilled in the art.

In some implementations, the server 200 can be configured to wait until at least a threshold amount of training data is available before carrying out the aggregation process. For example, the server 200 can be configured to receive notifications of the number of examples collected for each label from one or more of the plurality of client devices 100a-100c. In some implementations, there can be a threshold for the amount of data required for each label. In some implementations, there can be a target ratio between the number of examples per label. For example, it can be desirable to keep the amount of data approximately balanced between the classes, thus, the target ratio can be 50:50 or equivalent for where there are more than two classes. The server 200 can be configured to select the client devices to receive training data from based upon the received notifications. For example, the client devices can be selected based upon the target ratio. The server 200 can be configured to transmit a request to the selected client devices for training data. In some cases, the request can comprise an indication of the number of examples required per class. As such, if the training data is in aggregated form, network bandwidth requirements are reduced for transmitting the training data to the server. However, it can potentially be more difficult to select training data to satisfy a target ratio.

In some implementations, the server 200 can be configured to carry out the aggregation iteratively. For example, if training data is received from each client device in aggregated form, e.g. as local steering vectors, the server 200 can be configured to iteratively aggregate a local steering vector into the global steering vector one at a time or in batches. Alternatively, if training data is received as individual examples, the server 200 can be configured to divide the training data into batches and iteratively update the global steering vector by aggregating each batch into the global steering vector. In either case, the server 200 can be configured to determine whether or not the global steering vector has converged, e.g. at the end of each iteration. For example, the server 200 can determine the rate of change of the global steering vector and if the rate of change is below a threshold, i.e. the global steering vector is changing very slowly, the global steering vector can be considered to have converged. If the global steering vector has converged, the server 200 can be configured to end the aggregation process early, or the aggregation can proceed until all of the training data has been used.

If the server 200 completes the aggregation of the available training data and the global steering vector has not yet converged, the server 200 can be configured to request further training data from other client devices. Thus, the server 200 can be configured to receive further training data comprising further training activations from one or more second client devices. The server 200 can be configured to carry out another round of client device selection for this purpose. The server 200 can be configured to update the global steering vector based upon an aggregation with further training data/activations. The server 200 can be configured to continue updating the global steering vector until convergence or no further training data is available from any client devices or a threshold number of iterations have been reached.

In some implementations, the server 200 can be configured to request training data from client devices according to a batch size. The server 200 can be configured to update the global steering vector by aggregating the batch of training data accordingly and to determine whether or not the global steering vector has converged before proceeding to request another batch of training data from appropriate client devices.

In some implementations, the plurality of client devices 100a-100c can be configured to transmit their available training data without a request from a server 200. In these implementations, the server 200 can be configured to select appropriate activations from the received training data to aggregate/update the global steering vector with. The selection from the received training data can be carried out according to a target ratio and threshold amounts of data as described above for client device selection.

As shown in FIG. 2, the server 200 can include an aggregation subsystem 202 configured to carry out the aggregation processing described above.

The server 200 can be configured to transmit the final steering vector 203 to the plurality of client devices. This can include the first client devices 100a and 100b. This can also include any second client devices. This can also include any other client devices that did not transmit training data to the server 200, for example, client device 100c shown in FIG. 2.

In some implementations, the plurality of client devices 100a-100c can be configured to continue to collect training data when applying the received steering vectors during neural network inference. The above-described processes can be repeated and thus, the steering vectors can be continuously updated and refined.

In some implementations, the server 200 can be configured to aggregate the activations for the respective selected layer to generate a steering vector for the respective selected layer based upon a Secure Aggregation protocol. For example, as noted above, some implementations of Secure Aggregation can involve a server-mediated key agreement.

Referring now to FIG. 3, a client device 300 is shown. The client device 300 can be the same as the client device 100 of FIG. 1. The client device 300 can be configured according to any of the plurality of client devices 100a-100c of FIG. 2.

The client device 300 includes a neural network 301 that comprises a plurality of layers 301a-301e. The client device 300 is configured to receive one or more steering vectors 302 associated with one or more selected layers of the neural network 301. The one or more steering vectors 302 are received from a server such as the server 200 of FIG. 2. The one or more steering vectors 302 can be generated according to the techniques described above.

The client device 300 can include a receiver 303 for receiving the one or more steering vectors 302. The one or more steering vectors 302 can be received using any appropriate network connection such as a LAN, a WLAN, cellular connection, Internet connection etc. The client device 300 can also include data storage 304 to store the one or more steering vectors 302 for subsequent use.

The client device 300 is configured to obtain a model input 305 that is processed by the neural network 301 to generate a model output 306. The neural network 301 can be configured to carry out any appropriate task as described above.

When processing the model input 305 to generate the model output 306, the client device 300 is configured to generate activations for each layer of the neural network 301. However, for each of the respective selected layers, after generating the activation for that layer, the associated steering vector is applied to generate a modified activation for that layer. Then, the generation of activations for all subsequent layers that have the respective selected layer as an input is based upon the modified activation.

For example, in FIG. 3, layer 301c is the selected layer. Processing of the model input 305 through all layers up to the selected layer 301c occurs as normal. The activations for the selected layer 301c are computed and the steering vector 302 is then applied to the activations to generate a modified activation for the selected layer 301c. For example, the steering vector 302 can be added to the output of the selected layer 301c. In other examples, the steering vector 302 can be scaled (e.g. using a tuneable hyperparameter) before being applied. In some implementations, the activations of the selected layer 301c can be an intermediate result and the steering vector 302 is applied to the intermediate result before processing continues to generate the output of the selected layer 301c to provide the modified activations. The output of the selected layer 301c is provided as input to the next layer 301d of the neural network 301 and processing continues as normal to generate the model output 306. Where there is more than one selected layer, the above can be repeated for each selected layer in turn.

In this way, a neural network's response to any model input can be modified in accordance with the steering vector. Steering vectors can be used to adjust the behaviour of a neural network without necessarily having to fine-tune the network through backpropagation, which has high memory requirements, or through other computationally expensive training methods.

In some implementations, the client device 300 can be configured to personalize the received steering vector 302. The client device 300 can be configured to collect further training data whilst applying the steering vector 302 during neural network processing. The client device 300 can be configured to update the steering vector 302 locally based upon the further training data.

In some implementations, steering vectors can be determined for individual software applications. However, to avoid a proliferation of the steering vectors, steering vectors for related contexts can be combined. For example, individual software applications that provide auto-complete suggestions for a software keyboard could each have their own steering vectors determined. These could however be combined according to their writing style or other appropriate characteristic. For example, users typically use more informal language in messaging applications compared to work related applications. Thus, the steering vectors for messaging applications could form one candidate group for merging whilst the steering vectors for work related applications could form another candidate group for merging steering vectors. Clustering techniques can be used to determine particular groupings and a representative steering vector for each group. The combining of steering vectors can be carried out at the server, in which case, the training data provided to the server can also comprise an indication of the application context. Alternatively, the combination can be carried out each the client device locally.

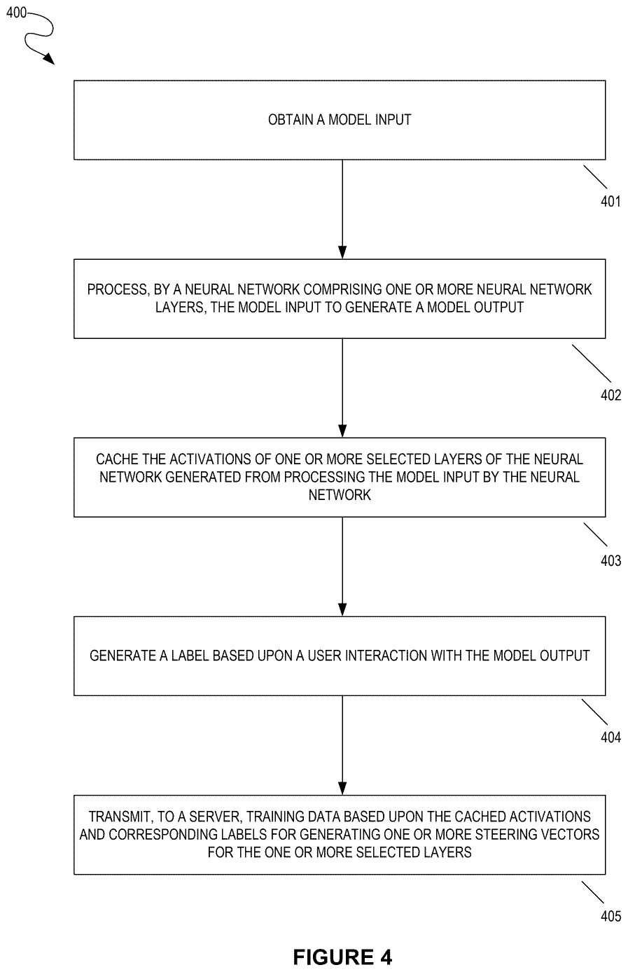

FIG. 4 is a flow diagram illustrating an example method 400 for federated learning implemented by a client device such as the client devices of FIGS. 1 to 3. As such, features described in the context of FIGS. 1 to 3 can also be applied to the method of FIG. 4.

At step 401, a model input is obtained and at step 402, the model input is processed by a neural network comprising one or more neural network layers to generate a model output. As described above, the neural network can be configured/trained to carry out any appropriate task. The neural network can have any number of layers and any appropriate architecture for carrying out the intended task. The model input can be generated based upon a user interaction with the client device or the model input can be generated by a software application or AI agent or through any other appropriate method.

At step 403, the activations of one or more selected layers of the neural network generated from processing the model input by the neural network are cached. The activations can be cached during the processing of the model input to generate the model output. Alternatively, the model input can be stored and the activations for the one or more selected layers can be reconstructed at a later point, for example, if it is not known which layers are to be the selected layers when the model input is obtained. As described above, the choice of which layer(s) to select can be considered to be a hyperparameter and can be selected according to any appropriate hyperparameter selection method such as a grid search.

In some implementations, the activations of a selected layer is the output of that particular layer. In other implementations, the activations can be any intermediate result produced by that layer.

At step 404, a label is generated based upon a user interaction with the model output. As described above, user interface elements can be presented with the model output for providing direct feedback on the model output, e.g. “thumbs-up” and “thumbs-down” icons. Alternatively, a label can be derived indirectly from how the user chooses to interact with the model output. This can be dependent on the context of the task being performed. For example, if the neural network is tasked with highlighting grammar errors in a passage of text and the user chooses to ignore a particular error, this can provide a signal that similar errors should not be flagged by the neural network again. In another example, if the user requests regeneration of the model output, e.g., a generated summary of a document, an image, video, or audio, this can indicate that the user was not satisfied with the generated model output and the neural network should avoid generating similar output for similar model input. Thus, in some implementations, the label can be a binary label that is indicative of positive or negative user feedback with respect to the model output (which can be derived from direct or indirect user feedback). In other implementations, the labels can be multi-class labels.

At step 405, training data based upon the cached activations and corresponding labels are transmitted to a server for generating one or more steering vectors. In this regard, further model inputs can be obtained and processed by the neural network and the activations of the one or more selected layers of the neural network cached. Corresponding labels for the cached activations can be generated.

In some implementations, the training data comprises the cached activations and corresponding labels. In other implementations, the training data comprises the cached activations modified using the corresponding labels. For example, as described above, where the labels are binary labels, the activations corresponding to a negative class can be multiplied by a negative value such as −1 to provide a weighted activation. The activations corresponding to a positive class can be unchanged or multiplied by a positive value. In further implementations, the training data comprises an aggregation of the cached activations modified using the corresponding labels. For example, as described above, the positively weighted activation values and negatively weighted activation values can be summed to effectively compute a weighted average of the activations. In other words, the difference between the average activations of a positive class and the average activations of a negative class can be computed. In other implementations, the training data can comprise an aggregation of the activations for each class without computing a difference between them.

Thus, the training data can comprise unmodified cached activations, the cached activations modified using their corresponding labels, or an aggregation of the cached activations (either modified or unmodified). The training data can comprise the corresponding labels as appropriate.

In some implementations, the training data can be modified based upon a Differential Privacy technique and/or the training data can be transmitted based upon a Secure Aggregation protocol as described above.

In some implementations, the server can be notified of the number of examples of each label/class that has been collected on the client device. As described above, the server can receive notifications from other client devices and select certain client devices to receive training data from. A request to transmit the training data can be received from the server and in response to the request, the client device can transmit the training data. In some implementations, only a subset of the training data available on the client device is transmitted in accordance with the request received from the server. For example, the request can comprise an indication of the number of examples per class that is required. If the number of available examples exceeds the number of examples requested, a random selection of the required number can be carried out or another suitable selection technique can be used.

In some implementations, a sparsity mask is applied to the training data prior to transmittal. As described above, the sparsity mask can define which elements of an activation vector to set to zero and which elements to retain. For example, when the training data comprises an aggregation of the cached activations, any values which are close to zero (e.g. below a certain threshold) can be marked for setting to zero. Alternatively, the top-N highest values can be marked for retention whilst all other values can be marked for setting to zero. In other implementations, the sparsity mask can be computed based upon the observed range of values of the cached activations, or using other methods, to determine the potential influence of each element. Those with low influence could be marked for setting to zero. In some implementations, the client device can negotiate and agree on a sparsity mask with other participating client devices. For example, each client device can exchange their proposed sparsity masks and combine them (e.g. by OR-ing each sparsity mask if the sparsity mask is a binary vector) to form the sparsity mask that is to be used. Once a final sparsity mask has been determined, the client device can apply the sparsity mask to the training data to set the corresponding values to zero.

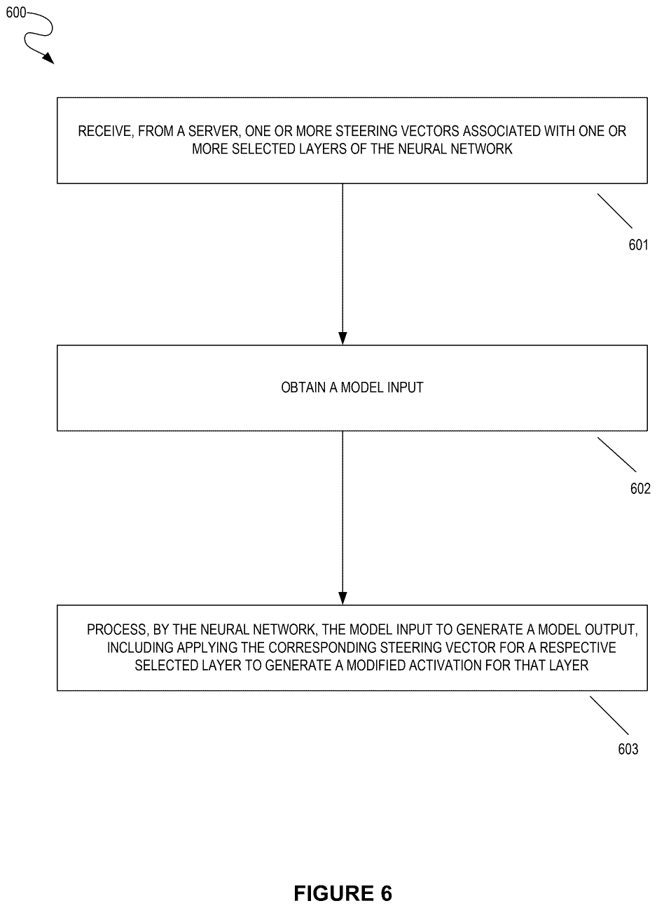

In some implementations, the method can further include receiving the one or more steering vectors from the server for subsequent application to the activations of the one or more selected layers when carrying out processing using the neural network. This is described in more detail below with reference to FIG. 6.

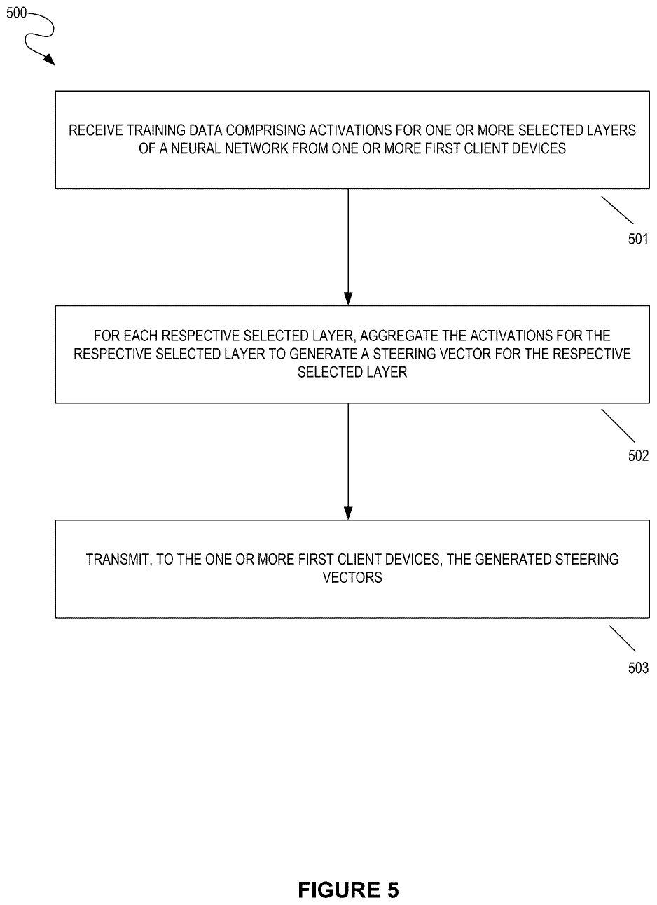

FIG. 5 is a flow diagram illustrating an example method 500 for federated learning implemented by a server such as the server of FIG. 2. As such, features described in the context of FIG. 2 can also be applied to the method of FIG. 5.

At step 501, training data comprising activations for one or more selected layers of a neural network from one or more first client devices is received. As discussed above, the activations can be in an aggregated form or can comprise individual examples of activations with corresponding labels.

At step 502, for each respective selected layer, the activations for the respective selected layer are aggregated to generate a steering vector for the respective selected layer. For example, as described above, if individual examples of activations are received from the one or more first client devices, a difference between the average activations for a positive class can be computed against the average activations for a negative class. This can be achieved, for example, by multiplying each individual activation example associated with the negative class by-1 and then summing all activations of both classes together. If the activations are received in aggregated form, an average of the aggregated activations weighted by the number of examples used in the aggregation can be computed in order to determine the steering vector. It will be appreciated that other forms of aggregation can be used as deemed appropriate by a person skilled in the art.

As described above, in some implementations, the server can wait until at least a threshold amount of training data is available before carrying out the aggregation process (step 502). For example, notifications of the number of examples collected for each label on the respective client device can be received from a plurality of client devices. The one or more first client devices can be selected based upon the received notifications. For example, the one or more first client devices can be selected based upon a target ratio between the number of the examples per label to be received by the server. For example, it can be desirable to keep the amount of data approximately balanced between the classes, thus, the target ratio can be 50:50 or equivalent for where there are more than two classes.

As described above, in some implementations, the aggregation is performed iteratively. For example, the training data can be divided into batches and each batch is iteratively aggregated into the steering vector. A batch can be any size, including one. At the end of each iteration (or other appropriate time step), the server can determine whether or not the steering vector has converged. For example, whether the rate of change of the steering vector is below a threshold amount, that is, changing very slowly. If the steering vector has converged, then the aggregation process can be ended early or the aggregation can proceed until all of the training data has been used.

If the steering vector has not converged and there is no further training data available on the server, the server can request further training data from one or more second client devices. Thus, the server can receive further training data comprising further activations for the respective selected layer from the second client devices and update the steering vector based upon an aggregation with the further activations. The server can continue updating the steering vector until convergence or no further training data is available from any client devices or a threshold number of iterations have been reached.

At step 503, the generated steering vectors are transmitted to the one or more first client devices. The generated steering vectors can also be transmitted to the one or more second devices and more generally to any device that provided training data. In addition, the generated steering vectors can also be transmitted to one or more other client devices that did not provide any training data.

In some implementations, aggregating the activations for the respective selected layer to generate a steering vector for the respective selected layer can be based upon a Secure Aggregation protocol as noted above.

FIG. 6 is a flow diagram illustrating an example method 600 for neural network processing implemented by a client device such as the client device of FIG. 3. As such, features described in the context of FIG. 3 can also be applied to the method of FIG. 6.

At step 601, one or more steering vectors associated with one or more selected layers of a neural network are received from a server. The one or more steering vectors can be generated according to the techniques described above.

At step 602, a model input is obtained and at step 603, the model input is processed by the neural network to generate model output. More specifically, the activations for each layer of the neural network are generated. After generating the activation of a respective selected layer of the neural network, the corresponding steering vector is applied to generate a modified activation for that layer. The activations for all subsequent layers of the neural network that have the respective selected layer as an input are then based upon the modified activation. For example, the model input can be processed through all the layers of the neural network up to the selected layer as normal. The activations for the selected layer are computed and the steering vector is then applied to the activations to generate a modified activation for the selected layer. For example, the steering vector can be added to the output of the selected layer. In other examples, the steering vector can be scaled (e.g. using a tuneable hyperparameter) before being applied. In some implementations, the activations of the selected layer can be an intermediate result and the steering vector is applied to the intermediate result before processing continues to generate the output of the selected layer to provide the modified activations. The output of the selected layer is provided as input to the next layer of the neural network and processing continues as normal to generate the model output. Where there is more than one selected layer, the above can be repeated for each selected layer in turn.

The above described techniques can also be applied in client/server architectures involving the use of Trusted Execution Environments (TEEs). TEE is a secure hardware technique that enables secure computation in an untrusted server environment without exposing data or processing to the host server. A client device can securely offload operations to the TEE by transmitting data using a secure channel with operations carried out securely in confidential memory on the TEE. For example, the TEE can be used to implement a neural network and carry out neural network operations on behalf of the client device.

Typically, a TEE has limited computational resources available, such as memory. As discussed above, running backpropagation to train a neural network can be infeasible for devices with limited memory. Therefore, the techniques described above for generating and applying steering vectors can also be used in implementations involving TEEs. For example, a client device can securely transmit a model input to the TEE. A neural network implemented on the TEE can process the model input to generate a model output. The activations of one or more selected layers of the neural network generated from processing the model input can be cached. The model output can be securely transmitted back to the client device. The client device can receive user feedback pertaining to the model output to generate a label. The label can be securely transmitted to the TEE. Alternatively, the user feedback can be securely transmitted to the TEE for deriving the label. The TEE can process further model inputs from the client device and can also serve other client devices in the same way to build-up training data. The TEE can generate a steering vector from the training data as described above. The TEE can apply the steering vector during further subsequent processing of model inputs using the neural network as described above.

Further example tasks that a neural network can be trained to perform will now be described. It will be appreciated that the neural networks described above may be trained to perform any appropriate task and the below examples are illustrative and not intended to be limiting. The neural network can be configured to receive and process any type of digital input and to provide any type of digital output including a score, classification, or regression output. The input to and/or the output of the neural network may be sequential in nature as appropriate for the task.

In one example, a neural network may be configured to perform an image processing task. The neural network may be configured to receive and process image data as an input. The image data may comprise one or more values for each of a plurality of pixels, such as intensity values. Alternatively, the image data may comprise a low-level feature encoding of an image. The image data may comprise colour or monochrome data. The image data may be captured by an image sensor of a digital camera, LIDAR, infra-red camera or any other camera type. The image data may comprise a point cloud.

The image processing task may be an image classification task. The neural network may be configured to process input image data to provide an output indicating the presence of one or more object categories in the input image data. The indication may be a probability, a score or a binary indicator for a particular object category.

The image processing task may be an object detection task. The neural network may be configured to process input image data to provide an output indicating a location of one or more objects that have been detected in the input image data. The indication may be a bounding box, set of co-ordinates or other location indicator and the output may further comprise a label indicating the corresponding detected object.

The image processing task may be image segmentation. The neural network may be configured to process input image data to provide an output indicating an object category that a pixel (or each pixel) in the input image data belongs to.

The image processing task may be an image encoding task. The neural network may be configured to process input image data to provide a representation of the input image data. The representation may be a compressed encoding of the image data. The representation may be a numeric embedding of the input image.

The image processing task may be a depth estimation task. The neural network may be configured to process input image data to provide an output indicating an estimated depth of objects depicted in the image data. The output may be a depth map comprising an estimated depth value for each pixel of the input image data.

The image processing task may be a surface normal prediction task. The neural network may be configured to process input image data to provide an output indicating a predicted surface normal of objects in a scene. A predicted surface normal may be provided for each pixel in the image.

The image processing task may be a captioning task. The neural network may be configured to process input image data to provide an output comprising a sequence of text in natural language describing the objects depicted within the image.

The image processing task may be a de-noising or in-filling task. The neural network may be configured to process input image data to provide as output a version of the input image data that has reduced noise or artefacts or has missing data imputed.

In another example, the neural network may be configured to receive and process audio data as an input. The audio data may comprise any type of digital audio signal and may comprise raw digital samples of a waveform (e.g. amplitude values) or may be an encoding derived from an audio signal such as a spectrogram, mel-frequency cepstral co-efficients or other acoustic features/time-frequency domain representation. The audio data may be obtained from an audio transducer such as a microphone.

The audio data may comprise a speech signal. The audio processing task may be a speech processing task such as speech recognition. The neural network may be configured to process an input speech signal to provide output data comprising one or more probabilities or scores indicating that one or more words or sub-word units comprise a correct transcription of the speech contained within. Alternatively, the output data may comprise a transcription itself.

The audio processing task may be a keyword (“hotword”) spotting task. The neural network may be configured to process input audio data to provide an indication of whether a particular word or phrase is spoken in the input audio data.

The audio processing task may be a speaker recognition or verification task. The neural network may be configured to process input audio data to provide an indication of the identity of a speaker or to provide an indication of whether a particular speaker is present in the audio data.

The audio processing task may be a language recognition task. The neural network may be configured to process input audio data to provide an indication or delineation of one or more languages present in the input audio data.

The audio processing task may be a control task. The neural network may be configured to process input audio data comprising a spoken command for controlling a device to generate output data that causes the device to carry out actions corresponding to the spoken command.

In a further example, the neural network may be configured to receive and process text data. The neural network may be configured to perform a text-to-speech task. The neural network may be configured to process input text data to generate audio data comprising a spoken utterance corresponding to the input text data. This output audio data may be in a similar format to the input audio data for audio processing tasks described above.

The neural network may be configured to perform an image generation task. The neural network may be configured to process input text data to generate image data comprising objects corresponding to the input text data. The output image data may be in a similar format to the input image data for image processing tasks described above. The input to the neural network may comprise image data depicting an example object and the neural network may be configured to generate image data based upon the example object, e.g. a variant of the example object or another instance of an object of the same class as the example object. As such, the neural network may be conditioned on text, images or text and images.

The neural network may be configured to perform a neural machine translation task. The neural network may be configured to process input text data comprising text in one language to provide output data comprising one or more probabilities or scores indicating that one or more words or sub-word units in a second language is comprised in a proper translation of the input text data into the second language. Alternatively, the output data may comprise the translation itself.

The neural network may be configured to process input text data comprising instructions for controlling a device to generate output data that causes the device to carry out actions corresponding to the instructions.

The neural network may be part of a dialogue system. The neural network may be configured to perform a conditional text generation task. The neural network may be configured to process input text data comprising a user prompt to provide output text data that is a response to the user prompt. The user prompt may be a question and the response may be an answer to the question. The user prompt may be a text description of the function of computer code and the response may be computer code in a programming language that is configured to perform the function. The user prompt may be an initial sequence of computer code in a programming language and the response may be a further sequence of computer code that completes the initial sequence to perform a particular function.

The neural network may be configured to perform a natural language processing or understanding task. For example, the task may be an entailment task, a paraphrase task, a textual similarity task, a sentiment task, a sentence completion task, a grammar task or other similar task.

In another example, the neural network may be configured to receive and process video data. The video data may comprise a plurality of frames, e.g. image data, and audio data. The above described image and audio processing tasks may therefore also be applicable to video data.

In addition, the neural network may be configured to perform an action recognition or detection task. The neural network may be configured to process input video data to provide an output indicating the detection of one or more actions being performed in the video data and/or the spatial and temporal locations of the detected actions within the video data. The indications may be a probability or score indicating a particular action has been detected, the spatial location may be a bounding box or co-ordinates in the frames of the video, the temporal location may be a set of timestamps or frame numbers of the video.

In a further example, the neural network may be configured to process input video data to provide an output indicating optical flow between pixels of the image frames in the video.

In another example, the neural network may be configured to perform a video prediction task. The neural network may be configured to process input video data to provide an output that is a prediction of one or more subsequent frames following the last frame in the video.

In a further example, the neural network may be configured to perform a video generation task. The neural network may be configured to process input text data to generate video data comprising scenes with background, objects and motion corresponding to the input text data. Image data may also be provided as an input to the neural network. As such, the neural network may be conditioned on text, images or text and images.

In another example, the neural network may be configured to receive and process digital documents. The digital document may be an Internet resource or one or more portions or features extracted from an Internet resource. The neural network may be configured to classify the document. The neural network may be configured to process the digital document to provide an output indicating a classification of the digital document. The indication may be a probability, a score or a binary indicator for a particular category. The classification may be a topic of the document.

The neural network may be configured to receive and process features of a personalized recommendation for a user. For example, features characterizing the context for the recommendation such as features characterizing previous actions taken by the user. The neural network may generate an output comprising a probability or score for a particular content item representing the estimated likelihood that the user will respond favourably to being recommended the particular content item.

In another example, the neural network may be configured to perform a health prediction task. The neural network may be configured to receive and process electronic health record data. The neural network may be configured to generate an output comprising an indication of a diagnosis of a particular disease or health condition, or a prediction of the occurrence of an adverse health event, or a predicted treatment for the patient. The indication may be a probability or score.

In a further example, the neural network may be part of a data compression system. The neural network may be configured to process input data to provide a compressed version of the input data as output. The compressed data may be stored at an appropriate storage or memory device or transmitted to another device.

In another example, the neural network may be configured to perform a drug discovery task. The neural network may be configured to process a graph representing a molecule, a SMILES (Simplified Molecular Input Line Entry System) representation of a molecule, a DNA or RNA sequence, or text data describing one or more characteristics or properties of a molecule for synthesis to provide an output sequence representing a molecule for synthesis corresponding to the input data. A molecule may be synthesized according to the output sequence.

In another example, the neural network may be part of a reinforcement learning system. In general, in a reinforcement learning system an agent interacts with an environment in order to carry out a particular task. Observations characterizing the state of an environment may be received. The reinforcement learning system may select an action for an agent to perform based upon the received observations. The action performed by the agent may cause the environment to transition to a new state and the environment may provide a reward signal in response to agent's action. Further observations of the environment may be received and a new action may be selected based upon the further observations and the received reward if applicable. Actions for the agent to carry out may be selected based upon a history of observations of the environment and actions performed by the agent.

The reinforcement learning system may be configured to select an action for an agent to perform based upon the output of the neural network. For example, the neural network may be a policy network and may be configured to process the observation characterizing the state of the environment to provide a probability distribution (or set of scores) over a set of possible actions. An action may be selected by sampling an action from the probability distribution or the action with the highest probability/score may be selected. The reinforcement learning system may cause the agent to perform the selected action. Neural networks in reinforcement learning systems may perform other functions such as provide an estimate of the value of a being in a given state of the environment, provide an estimate of the value of carrying out a particular action, provide a model of the environment to predict state transitions and observations, or provide an estimate of the reward function of an environment amongst others. It will be appreciated that in all these cases, whilst a neural network may not directly select an agent action, the output of the neural network feeds into the process for the selection of an action.

The environment may be a real-world environment. The agent may be a mechanical or electronic agent interacting with the real-world environment to carry out a particular task. For example, the agent may be a robot or (semi-)autonomous vehicle. The agent may be tasked with navigating to a specified destination in the environment. The agent may be tasked with locating an object of interest in the environment. The agent may be tasked with moving an object of interest in the environment to a specified destination.

The observations of the environment may include image data, positional/location data of objects in the environment, including the agent, and/or sensor data. The sensor data may include data from cameras, distance sensors, position sensors, temperature sensors, sensors monitoring the state of components on the agent or in the environment amongst others. The observations may include data characterizing the state of the agent such as, position, linear or angular velocity, force, torque, acceleration, a global or relative pose of the agent or parts of an agent or objects in relation to the agent where appropriate. The observations may be in any number of dimensions and may be absolute or relative observations.

The actions may be control signals to control the agent such as data indicating a position, velocity, force, torque, acceleration, angles, voltage or current for the agent or components of the agent such as joints, motors, steering, brakes. Alternatively, the actions may be higher-level commands that an agent can interpret and convert to low-level control signals to execute the higher-level command.

In another example, the environment may be a real-world manufacturing environment for the manufacture of a product. The product may be any type of product such as a mechanical, chemical, biological or food product. Manufacturing may include any kind of process applied to a product such as treating a product to apply a coating, cleaning the product, deconstructing a product or any transformation of a product or materials. Manufacturing may also include the manufacture of intermediate elements. A manufacturing plant may comprise a plurality of manufacturing units including apparatus for chemical or biological processes and machines, including robots, for processing materials. The manufacturing plant may be configured to move intermediate elements between manufacturing units, such as using an assembly line or other methods of conveyance. Manufacture of a product may include the manufacture of a food product by a kitchen robot, e.g., cooking.

An agent may be a mechanical agent as described above, such as, a robot used in the manufacturing process. Alternatively, the agent may comprise an electronic agent configured to control one or more manufacturing units and/or parameters of a manufacturing process. The agent may comprise a control system configured to control the manufacturing process. The agent may be tasked with the manufacture of a product whilst minimizing resource usage such as electricity or water consumption and the consumption of materials and other consumables used in the manufacturing process. The reward may be based upon a metric measuring task performance. For example, the metric may measure the quality of the manufactured product, the manufacturing speed, the consumption of resources, or other physical costs.

The observations may include sensor data for monitoring the manufacturing process such as monitoring the state or configuration of materials, machines, processes and working environments. The sensors may be configured to sense mechanical movement or force, pressure, temperature; electrical conditions such as current, voltage, frequency, impedance; quantity, level, flow/movement rate or flow/movement path of one or more materials; physical or chemical conditions e.g. a physical state, shape or configuration or a chemical state such as pH; configurations of the units or machines such as the mechanical configuration of a unit or machine, or valve configurations; image or video sensors to capture image or video observations of the manufacturing units or of the machines or movement; or any other appropriate type of sensor. In the case of a machine such as a robot the observations from the sensors may include observations of position, linear or angular velocity, force, torque or acceleration, or pose of one or more parts of the machine, e.g. data characterizing the current state of the machine or robot or of an item held or processed by the machine or robot. The agent actions may manipulate the manufacturing process to alter such states. These may include actions to adjust the physical or chemical conditions of a manufacturing unit, or actions to control the movement of mechanical parts of a machine or joints of a robot. The actions may include actions imposing operating conditions on a manufacturing unit or machine, or actions that result in changes to settings to adjust, control, or switch on or off the operation of a manufacturing unit or machine.

In a further example, the environment may be a real-world environment comprising a service facility comprising a plurality of items of electronic equipment, such as a server farm or data centre, for example, a telecommunications data centre, or a computer data centre for storing or processing data, or any service facility. The service facility may also include ancillary control equipment that controls an operating environment of the items of equipment, for example, environmental control equipment such as temperature control e.g. cooling equipment, or air flow control or air conditioning equipment. The agent may be tasked with the operation of the service facility whilst minimizing resource usage such as electricity or water consumption. The reward may be based upon a metric measuring task performance. For example, the metric may measure the load or throughput of the facility, or the consumption of resources such as electricity, water or other materials such as consumables. The agent may comprise an electronic agent configured to control operation of the items of equipment, or to control operation of the ancillary, e.g. environmental, control equipment.

The observations may comprise any electronic signals representing the functioning of the facility or of equipment in the facility. For example, the observations may be obtained from sensors sensing a state of a physical environment of the facility or sensing a state of one or more of items of equipment or one or more items of ancillary control equipment. These include sensors configured to sense electrical conditions such as current, voltage, power or energy; a temperature of the facility; fluid flow, temperature or pressure within the facility or within a cooling system of the facility; or a physical facility configuration such as whether or not a vent is open.

The actions may be any actions that have an effect on the observed state of the environment, e.g. actions configured to adjust any of the sensed parameters. These may include actions to control, or to impose operating conditions on, the items of equipment or the ancillary control equipment, e.g. actions that result in changes to settings to adjust, control, or switch on or off the operation of an item of equipment or an item of ancillary control equipment.

In another example, the environment may be a real-world environment comprising a power generation facility, for example, a renewable power generation facility such as a solar farm or wind farm. The agent may be tasked to control the power generation facility, for example to optimize the times at which certain generation units are switched on or off to meet demand, and/or to control delivery of electricity to a power distribution grid. The reward may be based upon a metric measuring task performance. For example, in the case of a task to control the delivery of electrical power to the power distribution grid the metric may relate to a measure of power transferred, or to a measure of an electrical mismatch between the power generation facility and the grid such as a voltage, current, frequency or phase mismatch, or to a measure of electrical power or energy loss in the power generation facility. In the case of a task to maximize the delivery of electrical power to the power distribution grid the metric may relate to a measure of electrical power or energy transferred to the grid, or to a measure of electrical power or energy loss in the power generation facility.

The actions may comprise actions to control an electrical or mechanical configuration of an electrical power generator such as the electrical or mechanical configuration of one or more renewable power generating elements e.g. to control a configuration of a wind turbine or of a solar panel or panels or mirror, or the electrical or mechanical configuration of a rotating electrical power generation machine. Mechanical control actions may, for example, comprise actions that control the conversion of an energy input to an electrical energy output, e.g. an efficiency of the conversion or a degree of coupling of the energy input to the electrical energy output. Electrical control actions may, for example, comprise actions that control one or more of a voltage, current, frequency or phase of electrical power generated.

The observations may comprise any electronic signals representing the electrical or mechanical functioning of power generation equipment in the power generation facility. For example, the observations may be obtained from any sensors sensing a physical or electrical state of equipment in the power generation facility that is generating electrical power, or the physical environment of such equipment, or a condition of ancillary equipment supporting power generation equipment. Such sensors may include sensors configured to sense electrical conditions of the equipment such as current, voltage, power or energy; temperature or cooling of the physical environment; fluid flow; or a physical configuration of the equipment; and observations of an electrical condition of the grid e.g. from local or remote sensors. Observations may also comprise one or more predictions regarding future conditions of operation of the power generation equipment such as predictions of future wind levels or solar irradiance or predictions of a future electrical condition of the grid.

In a further example, the environment may be a chemical synthesis or protein folding environment such that each state is a respective state of a protein chain or of one or more intermediates or precursor chemicals. The agent may be a computer system for determining how to fold the protein chain or synthesize the chemical. The actions may be possible folding actions for folding the protein chain or actions for assembling precursor chemicals/intermediates and the result to be achieved may include, e.g., folding the protein so that the protein is stable and so that it achieves a particular biological function or providing a valid synthetic route for the chemical. As another example, the agent may be a mechanical agent that performs or controls the protein folding actions or chemical synthesis steps selected by the system automatically without human interaction. The observations may comprise direct or indirect observations of a state of the protein or /emical/ /termediates/ precursors and/or may be derived from simulation. In a similar way, the environment may be a drug design environment such that each state is a respective state of a potential pharmachemical drug. The agent may be a computer system for determining elements of the pharmachemical drug and/or a synthetic pathway for the pharmachemical drug. The drug/synthesis may be designed based on a reward derived from a target for the drug, for example in simulation. As another example, the agent may be a mechanical agent that performs or controls synthesis of the drug.

In another example, an agent may manage distribution of tasks across computing resources e.g. on a mobile device and/or in a data centre. The actions may include assigning tasks to particular computing resources. The reward may be based upon a load, latency, or throughput of the device or data centre and/or resource consumption such as power.

In another example, the observations may include textual or spoken instructions provided to the agent by a third-party (e.g., an operator of the agent). For example, the agent may be an autonomous vehicle, and a user of the autonomous vehicle may provide textual or spoken instructions to the agent (e.g., to navigate to a particular location).

In some implementations, the environment may be a simulation of the above described real-world environments. The simulation may be used to train the reinforcement learning system for example. This can avoid unnecessary wear and tear and damage to the real-world environment or real-world agent and can allow the system to be trained and evaluated on situations that occur rarely or are difficult or unsafe to re-create in the real-world environment. For example, the system may be partly trained using a simulation of the agent in a particular real-world environment, and afterwards deployed to control the real agent in the particular real-world environment. Thus, in such cases the observations of the simulated environment relate to the real-world environment, and the selected actions in the simulated environment relate to actions to be performed by the mechanical agent in the real-world environment.

In a further example, the environment may be an electrical, mechanical or electromechanical design environment, e.g. an environment in which the design of an electrical, mechanical or electro-mechanical entity is simulated. The simulated environment may be a simulation of a real-world environment in which the entity is intended to work. The task may be to design the entity. The observations may comprise observations that characterize the entity, i.e. observations of a mechanical shape or of an electrical, mechanical, or electro-mechanical configuration of the entity, or observations of parameters or properties of the entity. The actions may comprise actions that modify the entity e.g. that modify one or more of the observations. The reward may comprise one or more metrics of performance of the design of the entity. For example, the reward may relate to one or more physical characteristics of the entity such as weight or strength or to one or more electrical characteristics of the entity such as a measure of efficiency at performing a particular function for which the entity is designed. The design process may include outputting the design for manufacture, e.g. in the form of computer executable instructions for manufacturing the entity. The process may include making the entity according to the design. Thus, a design process of an entity may be optimized, e.g. by reinforcement learning, and then the optimized design output for manufacturing the entity, e.g. as computer executable instructions; an entity with the optimized design may then be manufactured.

Specific embodiments of the subject-matter have been described. It will be appreciated that the described embodiments are to be considered exemplary and non-limiting and that other embodiments will fall within the scope of the appended claims. For example, actions described as being carried out in a particular order may be carried out in a different order. Actions shown as being sequential may be carried out in parallel or using a combination of parallel and serial processing. Where a specific arrangement is described for carrying out a particular function, other suitable arrangements for carrying out the particular function may also fall within the scope of the claims. For example, actions carried out by a plurality of modules may be carried out by a singular module and vice versa.

1. A method for federated learning implemented by a client device, the method comprising:
obtaining a model input;
processing, by a neural network comprising one or more neural network layers, the model input to generate a model output;
caching the activations of one or more selected layers of the neural network generated from processing the model input by the neural network;
generating a label based upon a user interaction with the model output; and
transmitting, to a server, training data based upon the cached activations and corresponding labels for generating one or more steering vectors for the one or more selected layers.

2. The method of claim 1, wherein the method further comprises:
receiving, from the server, the one or more steering vectors for subsequent application to the activations of the one or more selected layers when carrying out processing using the neural network.

3. The method of claim 1, wherein the activations are cached during the processing, by the neural network comprising one or more neural network layers, the model input to generate a model output.

4. The method of claim 1, wherein the method further comprises:
caching the activations of the one or more selected layers of the neural network generated from processing further model input by the neural network; and
generating corresponding labels for the cached activations.

5. The method of claim 1, wherein the training data comprises the cached activations modified using the corresponding labels.

6. The method of claim 5, wherein the training data comprises an aggregation of the cached activations modified using the corresponding labels.

7. The method of claim 1, wherein the generated labels are binary labels indicating positive or negative user feedback with respect to the corresponding model output.

8. The method of claim 7, wherein each cached activation having a corresponding negative label is multiplied by a negative value.

9. The method of claim 1, wherein the training data is transmitted based upon a Secure Aggregation protocol.

10. The method of claim 1, wherein the training data is modified based upon a Differential Privacy technique prior to transmittal.

11. The method of claim 1, wherein transmitting, to the server, training data based upon the cached activations and corresponding label for generating a steering vector comprises:
notifying the server of the number of examples of each label that have been collected on the client device;
receiving, from the server, a request to transmit the training data; and
in response to the request from the server, transmitting the training data.

12. The method of claim 1, wherein the neural network is based upon a large language model or diffusion model.

13. The method of claim 1, wherein the method further comprises:
applying a sparsity mask to the training data prior to transmittal.

14. A method for neural network processing implemented by a client device, the neural network comprising one or more neural network layers, the method comprising:
receiving, from a server, one or more steering vectors associated with one or more selected layers of the neural network;
obtaining a model input;
processing, by the neural network, the model input to generate a model output;
wherein the processing comprises:
generating activations for each layer of the neural network;
wherein after generating the activation for a respective selected layer of the neural network, applying the corresponding steering vector for the respective selected layer to generate a modified activation for that layer; and
wherein generating the activations for all subsequent layers having the respective selected layer as an input is based upon the modified activation.

15. A method for federated learning implemented by a server, the method comprising:
receiving training data comprising activations for one or more selected layers of a neural network from one or more first client devices;
for each respective selected layer, aggregating the activations for the respective selected layer to generate a steering vector for the respective selected layer; and
transmitting, to the one or more first client devices, the generated steering vectors.

16. The method of claim 15, wherein the method further comprises:
receiving, from a plurality of client devices, notifications of the number of examples collected for each label on the respective client device; and
selecting the one or more first client devices based upon the received notifications.

17. The method of claim 16, wherein the one or more first client devices are selected based upon a target ratio between the number of the examples per label to be received by the server.

18. The method of claim 15, wherein aggregating the activations for the respective selected layer to generate a steering vector for the respective selected layer is an iterative process.

19. The method of claim 15, wherein the method further comprises:
transmitting the generated steering vectors to one or more other client devices that did not provide any training data.

20. The method of claim 15, wherein aggregating the activations for the respective selected layer to generate a steering vector for the respective selected layer is based upon a Secure Aggregation protocol.
